(19) United States
(12) Patent Application Publication
(10) Pub. No.: US 2024/0318595 A1
(43) Pub. Date: Sep. 26, 2024

(54) TURBOMACHINE FOR AN AIRCRAFT PROPULSION DRIVE

(71) Applicant: MTU Aero Engines AG, München (DE)

(72) Inventors: Istvan Bolgar, Sengenthal (DE); Simon Schuldt, Munich (DE); Alexander Woitalka, Munich (DE)

(73) Assignee: MTU Aero Engines AG, München (DE)

(21) Appl. No.: 18/605,020

(22) Filed: Mar. 14, 2024

(30) Foreign Application Priority Data
Mar. 24, 2023 (DE) 10 2023 107 536.5
Jun. 30, 2023 (DE) 10 2023 117 409.6

(51) Int. Cl. F02C 7/16; F02C 7/22

(52) U.S. Cl. CPC F02C 7/16; F02C 7/22; F05D 2260/213

(57) ABSTRACT

The invention relates to a turbomachine for a flight propulsion drive with a compressor, a combustion chamber, a turbine through which a gas flow flows in a flow direction of the turbomachine, and a heat exchanger downstream of the turbine, wherein the heat exchanger is equipped to generate steam from water using energy from the gas flow, which can be supplied with the fuel to the gas flow for combustion in the combustion chamber.

### BACKGROUND OF THE INVENTION

The invention relates to a turbomachine for a flight propulsion drive with a gas flow in a flow direction of the turbomachine through a compressor, a combustion chamber, a turbine and a heat exchanger downstream of the turbine, wherein the heat exchanger is equipped to use energy from the gas flow to produce steam from water, which can be supplied with the fuel to the gas flow for burning in the combustion chamber.

In order to reduce the negative environmental impact of air traffic, attempts are being made to use water or steam to improve the performance of flight propulsion drives and reduce emissions. For example, “Water-Enhanced Turbofan (WET)” technology relies on water injection into a combustion chamber. Here, steam is generated in a steam generator arranged downstream of an engine turbine by means of the exhaust energy, which is delivered in the combustion chamber region. After flowing through the steam generator, moist exhaust gas can flow through other components that are designed to separate water from the exhaust gas. The prerequisites for this WET-concept is an efficient recovery of the moisture from the exhaust gas and an efficiency-optimized use of the energy present in the turbomachine exhaust gas to generate steam from the recovered water.

### SUMMARY OF THE INVENTION

Starting from this, an object of the present invention is to propose an improved turbomachine for a flight propulsion drive, by means of which, particularly, an improvement in utilization of installation space and/or an improvement in efficiency is possible. This is accomplished in accordance with the invention by the teachings of the independent claims. Advantageous embodiments of the invention are the subject of the dependent claims.

In order to achieve the object, a turbomachine is proposed for a flight propulsion drive with a gas flow in the flow direction of the turbomachine through a compressor, a combustion chamber, a turbine and a heat exchanger downstream of the turbine, wherein the heat exchanger is equipped to use energy from the gas flow to produce steam from water, which can be supplied with the fuel to the gas flow for burning in the combustion chamber.

The heat exchanger has at least a predominantly horizontally extending heat exchange region, which has at least one flow channel through which water can flow, each flow channel essentially running in at least one horizontally extending plane, and the heat exchanger is designed in such a way that the gas flow can flow around the at least one, in particular each, flow channel in a direction perpendicular to the at least one plane.

In this way, particularly in the heat exchanger region, each of the fluid flows, that is, the water flow and the gas flow can be directed in discrete flow paths at essentially right angles to each other, thus enabling heat transfer in the cross-flow of the water and gas flow. Cross-flow means, for the purpose of the invention, that both the flows, or fluid-flows, stream or flow at an angle in the range of 90° to each other. In this way, average, flow-related deviations, and/or deviations which are unavoidable due to design considerations in the range of up to plus/minus 10° up to plus/minus 30° from a 90° angle are covered. Through cross-flow heat transfer, the water or steam can be brought to a predetermined temperature safely and efficiently.

The heat exchanger envisaged here particularly describes an evaporator. The proposed design of the heat exchanger means that, in contrast to a known rotationally symmetrical form, it can have an essentially flat or, in particular, cubic geometry, which can improve spatial integration into the turbomachine and/or interaction with other components of the turbomachine. For example, by the proposed arrangement of the fluid flows, the heat exchanger can be designed as a compact module and/or connected in series with other heat transfer equipment of the turbomachine. This can result in a reduction in the number, length and/or complexity of flow-guiding pipes or channels between two heat transfer pieces of equipment. In this way, pressure and heat losses can be reduced and/or weight can be reduced, especially in comparison to known turbomachines.

A turbomachine for a flight propulsion drive has a compressor, a combustion chamber and a turbine. During the operation of the turbomachine, air is compressed in a compressor, mixed with fuel and ignited in the combustion chamber in order to drive the turbine. Furthermore, the turbomachine can have a fuel preparation system to prepare the fuel before combustion in the combustion chamber, which can use the steam generated in the heat exchanger. The proposed turbomachine also has a heat exchanger arranged downstream of the turbine, in which water extracted in particular from the gas flow or the exhaust gas of the turbomachine and supplied to the heat exchanger can be converted to steam using the energy of the gas flow. In the context of the present disclosure, the gas flow after leaving the turbine is also referred to, in particular, as exhaust gas or exhaust gas flow. In the context of the present disclosure, the gas flow after leaving the turbine is, in particular, also referred to as exhaust gas or exhaust gas flow.

A flight propulsion drive or an aircraft engine, in particular, can have such an axial turbomachine, wherein the turbomachine is equipped with an exhaust gas treatment unit which is particularly arranged downstream of the turbine of the turbomachine. The exhaust gas treatment device can comprise a heat exchanger, a cooling device, and a water separator device. The gas flow can flow through the heat exchanger, the cooling device and the water separator device in succession. Correspondingly, the heat exchanger, the cooling device and the water separation device can be arranged at least partially on an exhaust gas duct of the exhaust gas treatment device in the flow direction of the turbomachine. The gas flow after the turbine or an exhaust gas of the aircraft engine or the turbine can be cooled down to a temperature lower than the gas temperature at the turbine outlet or an initial exhaust gas temperature. Here, energy is removed from the heat exchanger, which is then used to generate steam, whereby the temperature of the gas flow is reduced.

The cooling device arranged downstream in the flow direction of the heat exchanger can be designed as a condenser (condenser heat exchanger) or can have a condenser which uses the ambient air as cooling fluid, which can, for example, be conveyed by a blower or a fan of the aircraft engine. This condenser heat exchanger can essentially have two regions, wherein in the first upstream region an (additional) cooling of essentially a gaseous exhaust gas flow takes place. In a second region downstream of the first region, the exhaust gas is cooled, so that the liquid water content present in the exhaust gas flow can be extracted from the exhaust gas flow. The liquid water content can be separated from the gas flow in the water separator device and supplied to the heat exchanger for steam generation. The separated water can be supplied to the steam generator or heat exchanger by means of a feed device, wherein the water can optionally be supplied to a water reservoir through a water treatment system, where it can be stored for further use. This enables the water to be supplied to the heat exchanger or the supplied water to be partially kept in a circuit, which means that an additional water supply for the combustion process can be dispensed with.

At least a portion of the steam generated in the heat exchanger can be conveyed to a mixing chamber of a fuel preparation system through a steam pipe or steam supply. Fuel can be introduced into this mixing chamber and fed to the steam supplied there, in order to vaporize the fuel. Thus, a mixture of steam and fuel can be formed, which can eventually be supplied to the combustion chamber of the turbomachine for combustion. In some embodiments, the steam can also be supplied to the gas flow before and/or in the combustion chamber.

In a turbomachine, particularly one that employs a WET-concept, the heat exchanger undertakes primarily two functions: On the one hand, energy is extracted from the gas flow, whereby the temperature of the gas flow drops so as to extract water from the gas flow, and on the other hand, this energy is specifically used to heat water/generate steam which is extracted from the gas flow and to supply this steam to the combustion chamber.

In this context, the invention is based, among other things, on the idea of designing a fluid flow in the heat exchange region of the heat exchanger so as to achieve a flow configuration of a cross-flow heat exchanger. In the at least one flow channel, the water can cross-flow relative to the exhaust gas or the gas flow, which streams or flows outside of the at least one flow channel. The heat transfer between water and gas flow can take place primarily in the horizontally extending heat exchange region, in which the gas flow can flow from all sides or be crossed by the at least one flow channel and heat can be transferred from the gas flow to the water, in particular by means of convection. By means of the cross-flow occurring in this manner, a temperature difference between the gas flow and the water to be evaporated in the heat exchanger can be used to evaporate the water and in particular to heat it to a predetermined temperature. In this way, steam generation or an overheating of the steam generated in the heat exchanger can be made more efficient.

The heat exchange region of the heat exchanger and the at least one flow channel arranged therein extend in the turbomachine in particular when the aircraft is stationary or when the turbomachine is in cruise flight in a horizontally extending plane. In the context of the present invention, it is assumed that the rotational axis and therefore the flow direction of the turbomachine is arranged horizontal when the aircraft is stationary or during cruise flight and therefore parallel to an extension of the turbomachine. The heat exchange region and the at least one flow channel arranged therein therefore have a longitudinal and/or transverse extension which is/are in particular larger than their vertical extension and/or extends/extend essentially parallel to a tangent of the earth's surface. This results in an at least essentially cuboid geometry of the heat exchanger, particularly in conjunction with the proposed flow configuration, whereby it can be better integrated within the installation space of the turbomachine. Through the proposed design, the heat exchanger can be made smaller and lighter, which means that a weight reduction of the heat exchanger and in turn the turbomachine can be achieved. In the overall context, a higher thermal efficiency of the turbomachine can be achieved by using the exhaust gas energy, and the formation of contrails can also be minimized.

In one embodiment, the at least one flow channel has at least two sections arranged parallel to one another and running in several parallel, horizontally extending planes. The sections are connected to one another so that the water can flow through the sections of the at least one flow channel one after the other, in particular in a meandering manner. As a result, the water can form a flow configuration of a countercurrent heat exchanger with the gas flow, whereby the water can flow or be guided in horizontally opposite directions in two adjacent sections and a gas flow perpendicular to the sections is possible. Thus, a contact time between the flow channel and the gas flow for the heat transfer process can be prolonged, whereby a temperature efficiency and a heat transfer efficiency can be improved. In one embodiment, the at least one flow channel runs essentially parallel to the flow direction of the turbomachine. This global flow direction of the turbomachine extends essentially parallel to the axis of rotation of the turbomachine. In this way, a particularly homogeneous distribution of gas flow, which is for most part vertical, can be achieved with respect to the at least one flow channel in order to transfer uniform quantities of heat to the water via the at least one flow channel.

In one embodiment, the heat exchanger has a plurality of flow channels arranged parallel to one another; the flow channels are arranged, in particular, at the same distance from one another. Here, the flow channels can be identically designed and can be arranged adjacent to one another in one or more particularly vertically oriented parallel planes. In this arrangement, the gas flows in and around several flow channels at the same time, particularly homogeneously and/or uniformly, and thus enables appropriate heat transfer. For this, the heat exchanger can be designed, for example, as a shell-and-tube heat exchanger or shell-and-tube recuperator, with the flow channels forming the tube bundle or tubes.

In one embodiment, the water in the heat exchange region of the heat exchanger can be guided essentially perpendicular to the direction of gravity by means of the at least one flow channel. Gravity or gravitational force is directed perpendicular to the earth's surface and is therefore perpendicular to all horizontal planes. In particular, the at least one flow channel has several parallel sections or sections arranged in several parallel horizontal planes, with the water being fed to the at least one flow channel in a lowermost plane. The water is usually supplied to the at least one flow channel in a liquid state and as it flows through the flow channel, it evaporates or converts into a gaseous state due to increasing heat supplied by the gas flow. When water evaporates, it passes through inherently different phase states. This phase change can cause changes in the material properties, in particular a density, a volume and a flow speed of the water. Such changes can be used for directing the water against the direction of gravity and support it.

In one embodiment, the gas flow in the heat exchange region of the heat exchanger can be guided, at least in sections, in the direction of gravity by means of the heat exchanger. Here, the gas flow can have the hottest temperature when entering the heat exchange region and thus release the most energy or heat in an upper area of the at least one flow channel facing the inlet. In particular, if the water is guided in the at least one flow channel against the direction of gravity, the greatest amount of heat is available in a region in which the water is already predominantly in a vaporous state. In this way, superheated water vapor can be generated in the heat exchanger from the exhaust gas energy in the turbine, which has a high energy density.

In one embodiment, the gas flow can be directed from the turbine to the at least one flow channel or the heat exchange region of the heat exchanger by means of a manifold of the heat exchanger. The gas flow can have a temperature between 800 and 980 K at the turbine outlet, in particular when exiting a low-pressure turbine. By means of the manifold, the gas flow can be directed immediately and with reduced loss to the at least one flow channel or the heat exchange region of the heat exchanger to provide the available energy for generating steam. In this way, superheated steam with a high energy density can be generated and undesirable condensation of the evaporated water can be avoided, for example in the region of the fuel preparation system, until the fuel contained in the mixture is burned in the combustion chamber.

In one embodiment, the manifold has a deflecting mechanism by means of which the gas flow can be deflected in such a way that it is essentially perpendicular to the at least one horizontally extending plane in which, in particular, the at least one flow channel and/or its section(s) is/are arranged, and can be introduced into the heat exchange region of the heat exchanger. In order to facilitate cross-flow heat transfer, a deflection of the gas flow from or with reference to the flow direction or a main flow axis of the turbomachine can be achieved here by means of the deflecting mechanism of the manifold of the heat exchanger and, if necessary, additionally or alternatively by suitable means in the heat exchange region.

In one embodiment, the heat exchange region of the heat exchanger is essentially planar in form. Here, the heat exchange region has a particularly flat and/or has a cuboid design with a predominantly horizontal extension or is designed essentially flat and/or has a cuboid design with a predominantly horizontal extension (flat). In particular, the heat exchanger also has an overall flat and/or cuboid design with a predominantly horizontal extension. In this way, for example, structural integration into the exhaust gas treatment device and an interaction with other components in the WET concept, such as the condenser, can be improved, in particular by changing the flow direction of the gas flow. In this way, for example, fewer gas flow channels between the heat exchanger and the condenser will be required, which means that pressure and heat losses can be reduced.

Within the meaning of the present disclosure, a horizontal orientation of components and/or planes is understood to be in a usual orientation of an aircraft or of the aircraft propulsion drive during cruise flight operations. It goes without saying that deviations from the horizontal alignment, which result from a different spatial position of the aircraft or of the aircraft propulsion drive, are included in the disclosure.

Additional features, advantages and possible applications of the disclosure arise from the following description in conjunction with the figures. In general, features of the various exemplary aspects and/or embodiments described herein may be combined with one another unless they are explicitly excluded in the context of the disclosure.

### BRIEF DESCRIPTION OF THE DRAWING FIGURES

In the following part of the description, reference is made to the figures, which illustrate specific aspects and embodiments of the present invention. It is obvious that other aspects can be used and that structural or logical changes to the illustrated embodiments are possible without departing from the scope of the present invention. The following description of the figures is therefore not to be understood as being limiting. Shown are:

FIG. 1 shows a schematic representation according to the invention of an exemplary turbomachine for a flight propulsion drive; and

FIGS. 2a, 2b each show a schematic representation of a heat exchanger of a turbomachine according to an exemplary embodiment of the present disclosure; and

FIGS. 3a, 3b each show a schematic representation of a sectional plane A or B from FIG. 2b of a heat exchange region of a heat exchanger of a turbomachine according to an exemplary embodiment of the present disclosure.

### DESCRIPTION OF THE INVENTION

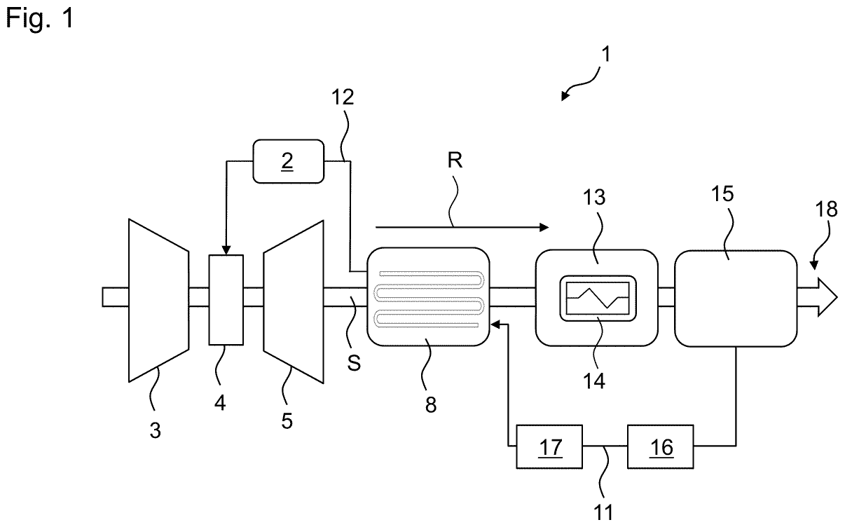

FIG. 1 shows a schematic representation according to the invention of an exemplary turbomachine for a flight propulsion drive.

The turbomachine 1 is designed, for example, as a turbofan and has a compressor 3, a combustion chamber 4 and a turbine 5, through which a gas flow S flows in a flow direction R of the turbomachine 1 or through which gas flow S flows during an operation of the turbomachine 1. Downstream of the turbine 5 in the flow direction R, the turbomachine 1 has a heat exchanger 8 designed as an evaporator, which is equipped to generate steam from water using energy from the gas flow S.

This steam can be supplied via a steam feed 12, particularly combined with a fuel in the gas flow S for combustion in the combustion chamber 4. The steam feed 12 can have a mixing chamber 2 of a fuel preparation system, into which fuel can be introduced and thus fed to the steam introduced there, whereby the fuel can vaporize. A mixture can thus be formed from the steam and the fuel, which is fed to the combustion chamber 4 of the turbomachine 1. In some embodiments, the steam can also be supplied to the gas flow S in front of and/or in the combustion chamber 4.

Based on a global flow direction R of the gas flow S illustrated by an arrow, the gas flow S first passes the compressor 3, the combustion chamber 4 and the turbine 5. After the turbine 5, the gas flow S can also be referred to as the exhaust gas flow of the turbomachine 1. This (exhaust) gas flow S can flow from the turbine 5 into the heat exchanger 8, a cooling device 13 and a water separation device 15 which are arranged downstream in the flow direction of the gas flow S.

The cooling device 13 can be equipped with a condenser 14 for cooling with ambient air in order to separate any water present in the gas flow S. In the present embodiment, a water separator 15 is arranged downstream of the cooling device 13, which can be designed as a droplet separator to collect the water. The residual gas flow S can leave the turbomachine 1 through an outlet 18 and, in particular, can be released into the environment.

The separated water can, for example, be fed into a water reservoir 17 through an optional water treatment system 16, where it is available for further use. By means of a feed device 11, the water can be supplied to the heat exchanger 8 in order to generate steam, which can be fed to the gas flow S in the combustion chamber 4.

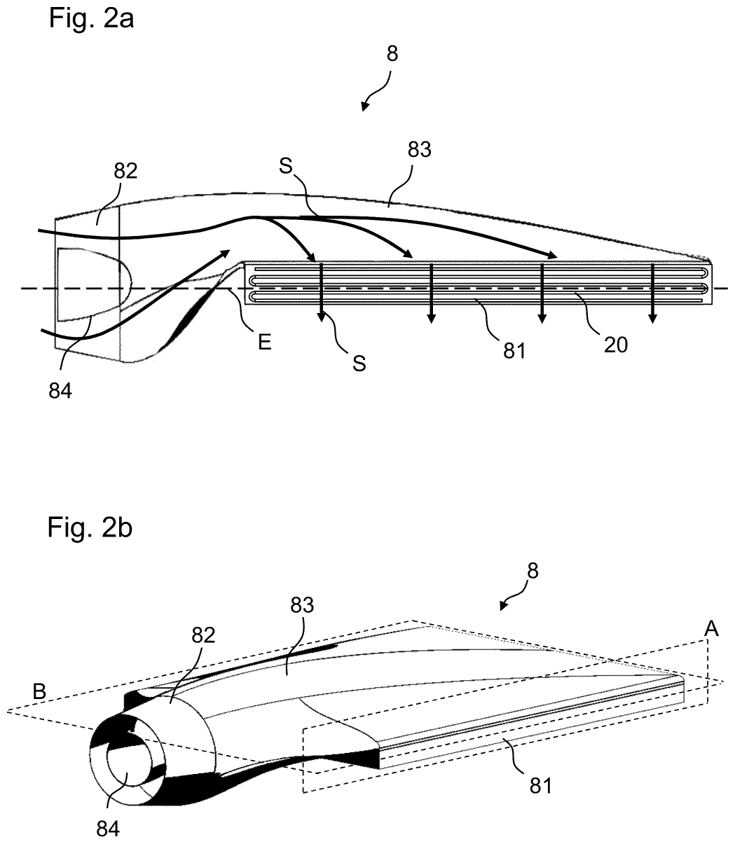

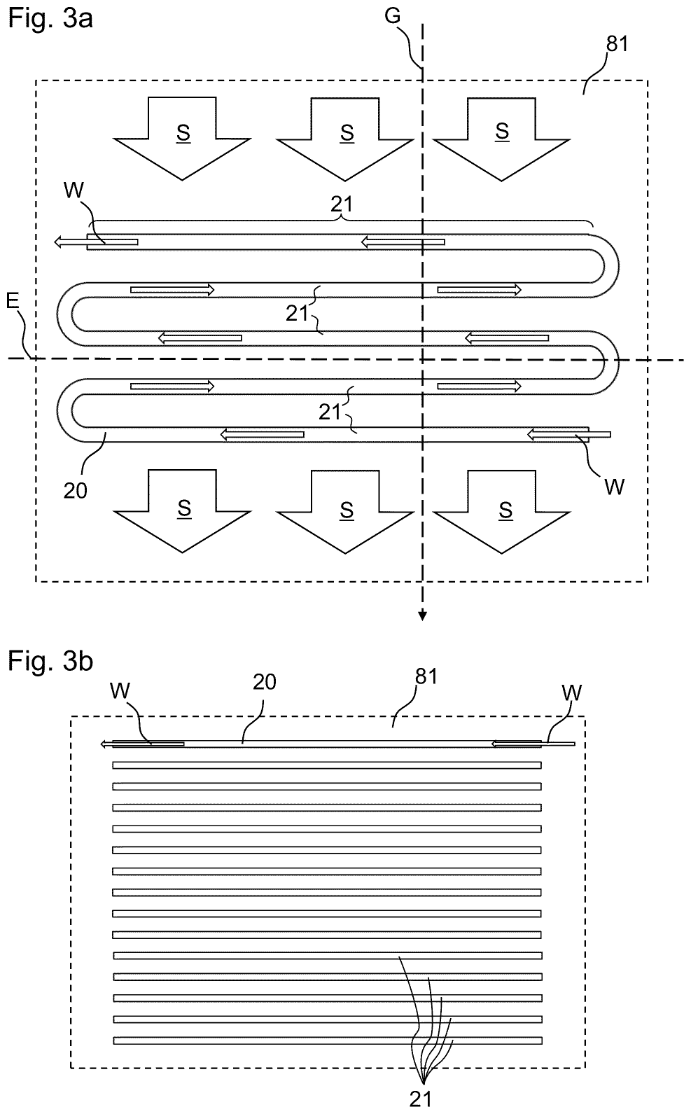

The heat exchanger 8 is described in more detail below in combination with FIGS. 2a, 2b and FIGS. 3a, 3b.

FIGS. 2a and 2b are schematic representations of an exemplary embodiment of a heat exchanger 8 as it may be envisaged in a turbomachine 1 shown in FIG. 1.

In FIG. 2a, the heat exchanger is illustrated as viewed in the direction of a horizontal plane E, whereby a line is drawn to illustrate the horizontal plane E. The heat exchange region 81 of the heat exchanger 8 is essentially planar and extends essentially horizontally, i.e. here perpendicular to the drawing plane. At least one flow channel 20 through which water can flow is arranged in the heat exchange region 81 (shown here in a schematic partial sectional view), wherein each flow channel 20 in the exemplary illustration of FIG. 2a extending essentially in five horizontally extending planes E (in installed condition in the turbomachine). The heat exchanger 8 is designed in such a way that the gas flow S can flow around the at least one flow channel 20 in a direction perpendicular to the at least one horizontal plane E.

At an end facing the turbine 5, the heat exchanger 8 has a manifold 82, by means of which the gas flow S can be directed from the turbine 5 to the at least one flow channel 20 or to the heat exchange region 81. The manifold 82 or the heat exchanger 8 has a deflecting mechanism 83 in the form of a housing curvature, by means of which the gas flow S can be introduced into the heat exchange region 81 of the heat exchanger 8 essentially perpendicular to the at least one horizontally extending plane E in order to flow around the flow channels 20 and thus enable heat transfer between the gas flow S and the water.

FIG. 2b shows a perspective view of the exemplary embodiment of a heat exchanger 8 from FIG. 2a. A conducting element 84 is arranged in the manifold 82, via which the gas flow S flowing from the turbine 5 can be guided into the deflector 83. Together with the deflector 83 and the heat exchange area 81, the manifold 82 forms an essentially flat or flat cuboidal outer geometry, which improves the spatial integration capability of the heat exchanger 8 in an installation space of the turbomachine 1.

FIG. 3a is a schematic representation of a sectional plane A shown in FIG. 2b of an exemplary embodiment of a heat exchange region 81 of a heat exchanger 8, such as may be envisaged in a turbomachine 1 of FIG. 1 or a heat exchanger 8 of FIGS. 2a and 2b.

Shown as an example, the heat exchange region 81 extends in the horizontal plane E and has at least one flow channel 20 through which the water W (illustrated by arrows) can flow. In the illustration in FIG. 3a, this flow channel 20 runs, except for the lateral connection sections, in five planes, which are arranged parallel to the horizontally extending plane E. Here, the flow channel 20 has five sections 21, which are arranged parallel to one another, and which run parallel to the horizontally extending plane E. Each of the sections 21 are connected to one another so that the water W can successively flow through the sections 21, wherein the water W flows in opposite directions in two adjacent sections 21. In addition, several flow channels 20 can be arranged parallel to one another and in particular at a vertical distance from the drawing plane of FIG. 3a.

The heat exchanger 8 and, in particular, the heat exchange region 81 are designed such that the gas flow S can flow around the at least one flow channel 20 in a direction perpendicular to the at least one plane E. In the illustrated embodiment, the gas flow S in the heat exchange region 81 can be directed in the direction of gravity G or flows in the direction of gravity. The gravity G or the gravitational force (illustrated by an arrow) is directed perpendicular to the earth's surface and is therefore perpendicular to every horizontal plane E.

In addition, in the exemplary embodiment, the water W can be directed at least in the heat exchange region 81 of the heat exchanger 8 by means of the at least one flow channel 20 essentially against the direction of gravity G. Here, the water W can particularly be supplied to each of the flow channels 20 in a lowermost section 21 and successively flow through the parallel sections 21 in order to leave the flow channel 20 through an uppermost section 21. Here, changes in fluid volume or material properties of the water W caused by heat absorption and evaporation can be used to guide the water W opposite to the direction of gravity G. This results in a heat transfer in the crosscurrent flow of the water W and the gas flow S for the heat exchange region 81 of the heat exchanger 8. The water W and the gas flow S flow essentially at a 90° angle relative to one another, including deviations in some sections, for example in the range of up to plus/minus 30°.

FIG. 3b is a schematic representation of a sectional plane B shown in FIG. 2b of an exemplary embodiment of a heat exchange region 81 of a heat exchanger 8 such as may be envisaged in a turbomachine 1 of FIG. 1 or a heat exchanger 8 of FIGS. 2a and 2b.

The heat exchange region 81 extends in a horizontal plane E and has a plurality of flow channels 20 arranged parallel to one another in this plane E, through which the water W can flow, each of which has a plurality of sections 21 arranged in parallel horizontal planes E (see FIG. 3a). The gas flow S flows around the flow channels 20 in a direction perpendicular to the plane of the drawing or plane E in order to transfer energy to the water.

What is claimed is:

1. A turbomachine for an aircraft propulsion drive, comprising:
a compressor, a combustion chamber, a turbine and a heat exchanger downstream of the turbine having a gas flow in a flow direction of the turbomachine therethrough,
the heat exchanger being configured and arranged to use energy from the gas flow to produce steam from water, which can be supplied with fuel to the gas flow for burning in the combustion chamber,
the heat exchanger including a horizontally extending heat exchange region with at least one flow channel through which water flows, each flow channel running in at least one horizontally extending plane, and
the heat exchanger being configured and arranged with the at least one flow channel of the gas flow flowing in a direction perpendicular to the at least one plane.

2. The turbomachine according to claim 1, wherein the at least one flow channel has at least two sections arranged parallel to each other, which run in several parallel and horizontally extending planes.

3. The turbomachine according to claim 1, wherein the at least one flow channel runs parallel to the flow direction of the turbomachine.

4. The turbomachine according to claim 1, wherein the heat exchanger has several flow channels arranged parallel to each other.

5. The turbomachine according to claim 1, wherein the water in the heat exchanger region of the heat exchanger flows against the direction of gravitation by the at least one flow channel.

6. The turbomachine according to claim 1, wherein the gas flow in the heat exchange region of the heat exchanger is directed at least section-wise in the direction of gravity by the heat exchanger.

7. The turbomachine according to claim 1, wherein the gas flow is directed from the turbine to the at least one heat exchange region by a manifold of the heat exchanger.

8. The turbomachine according to claim 1, wherein the manifold has a deflecting mechanism, by which the gas flow is deflected so that it is perpendicular to the at least one horizontally extending plane in the heat exchange region of the heat exchanger.

9. The turbomachine according to claim 1, wherein the heat exchange region of the heat exchanger is planar in form.
